(19) United States
(12) Patent Application Publication
(10) Pub. No.: US 2020/0099273 A1
(43) Pub. Date: Mar. 26, 2020

(54) POWER-SAVING ELECTRICAL DEVICE

(71) Applicants: Teng-Hung WANG, Tainan (TW); Tsung-Han WANG, Tainan (TW)

(72) Inventors: Teng-Hung WANG, Tainan (TW); Tsung-Han WANG, Tainan (TW)

(21) Appl. No.: 16/138,567

(22) Filed: Sep. 21, 2018

(51) Int. Cl. H02K 7/02; G05F 1/66; H02J 3/30

(52) U.S. Cl. CPC H02K 7/025; H02J 15/00; H02J 3/30; G05F 1/66

(57) ABSTRACT

The present invention discloses a power-saving electrical device, which employs a mechanical power system energized by an initial power supply to rotate a flywheel. Due to the principle of inertia, the flywheel enables the mechanical power system to provide a large torque. The flywheel is connected to an electrical generator so that the mechanical power system can drive the electrical generator to generate a large amount of electrical power, thus achieving the effect of energy saving. In addition, surplus power at the electrical generator can be fed back to a power storage device, which has the function of providing electrical power to initiate the mechanical power system.

### (a) TECHNICAL FIELD OF THE INVENTION

The present invention relates to a power-saving electrical device and, more particularly, to an electrical device, which empolys a mechanical power system energized by an initial power supply to rotate a flywheel, so that a large torque can be produced, wherein an output shaft of the flywheel is connected to an electrical generator so that the mechanical power system can drive the electrical generator to generate a large amount of electrical power, thus achieving the effect of power saving, and surplus power at the electrical generator can be fed back to a power storage device, which has the function of providing electrical power to initiate the mechanical power system.

### (b) DESCRIPTION OF THE PRIOR ART

In recent years, the earth is facing a crisis of energy depletion, and thus restriction of electricity use is often taken to slow down the energy consumption. To solve this problem, countries around the world try to develop new technology that uses wind, solar, hydraulic, coal-fired, or nuclear energy to generate electricity for reducing the energy being consumed.

However, wind, solar, and hydraulic power are limited by regional conditions, while coal-fired and nuclear power are polluting and have certain risks. To overcome the disadvantages of the existing power generation, after constant efforts, applicant has developed a power-saving electrical device.

### SUMMARY OF THE INVENTION

One object of the present invention is to provide a power-saving electrical device, which empolys a mechanical power system energized by an initial power supply to rotate a flywheel. Due to the principle of inertia, a large torque can be produced. An output shaft of the flywheel is connected to an electrical generator so that the mechanical power system can drive the electrical generator to generate a large amount of electrical power, thus achieving the effect of power saving. Surplus power at the electrical generator can be fed back to a power storage device, which has the function of providing electrical power to initiate the mechanical power system.

According to one aspect of the power-saving electrical device, the initial power supply can be a public grid system.

### BRIEF DESCRIPTION OF THE DRAWINGS

FIG. 1 shows a diagram illustrating the essential components of a power-saving electrical device according to one embodiment of the present invention.

FIG. 2 shows a diagram illustrating an application of the power-saving electrical device.

FIG. 3 shows a 3-dimensional view of the power-saving electrical device.

FIG. 4 shows a diagram of a power-saving electrical device, which includes additional sets of mechanical power systems and flywheels.

FIG. 5 shows a modified diagram of the power-saving electrical device in FIG. 1.

### DETAILED DESCRIPTION OF THE PREFERRED EMBODIMENTS

The power-saving electric device 10 of the present invention utilizes an initial power supply (A) to energize a mechanical power system 1. The initial power supply (A) can be a public grid system (B). The present invention was invented using the concept of reverse engineering. For example, in a household, factory, or site that uses electricity from a public grid system, the average electrical consumption can be obtained from the reading of the associated electric meter. Furthermore, the difference between the average electrical consumption and the rated power of a machine associated therewith can be estimated. Based on these data, a suitable electrical generator can be selected, and the torque required to operate the electrical generator can be calculated. For the motor 11, which can be energized by the public grid system (B), since the flywheel 11 connected at the output shaft of the motor 11 can increase the output torque of the motor 11, the electrical generator 3 can generate electricity several times more than an electrical generator without a flywheel. The electricity can be used in homes, factories, and any places where electricity is needed. In addition, surplus power at the electrical generator can be fed back to a power storage device 43, which has the function of providing electrical power to initiate the mechanical power system 1. Since the present invention allows the electrical power generation to be multiplied, less power input from the initial power supply (A) or the public grid system (B) is required to achieve a fixed average power consumption, thus achieving the effect of power saving (i.e. the electric meter will have a lower reading).

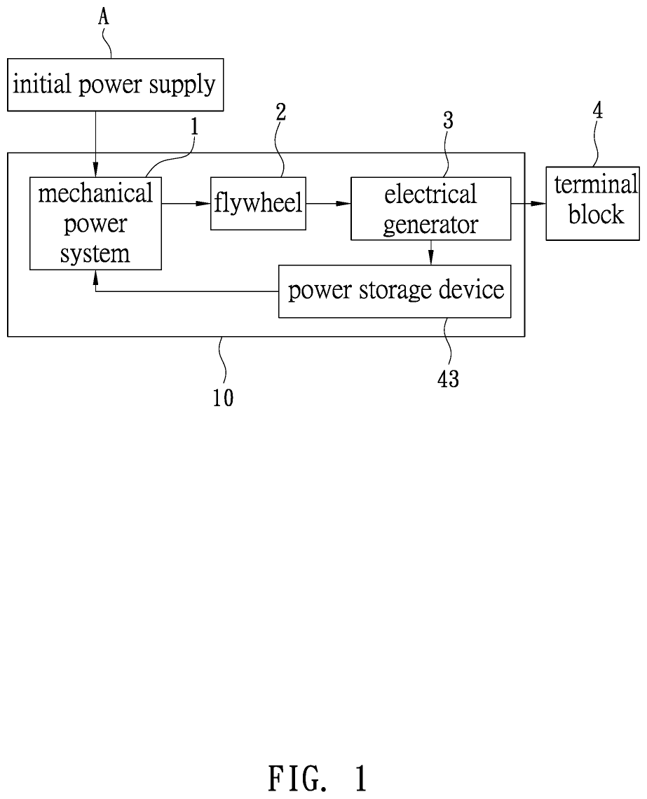

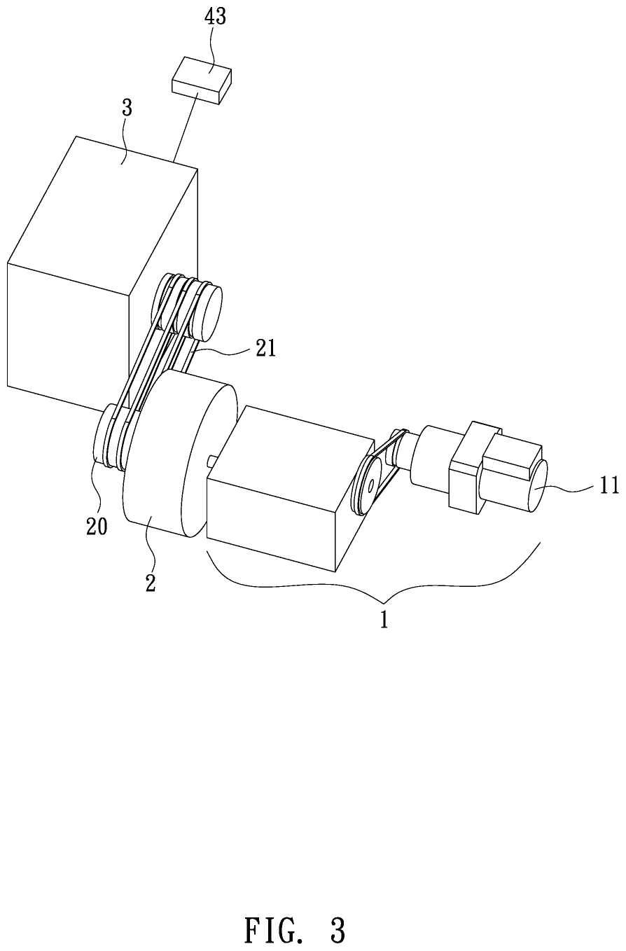

For a more detailed understanding of the structure of the present invention, referring first to FIGS. 1, 3 and 5, a power-saving electrical device 10 according to one embodiment of the present invention is shown, which generally comprises a mechanical power system 1, a flywheel 2, and an electrical generator 3.

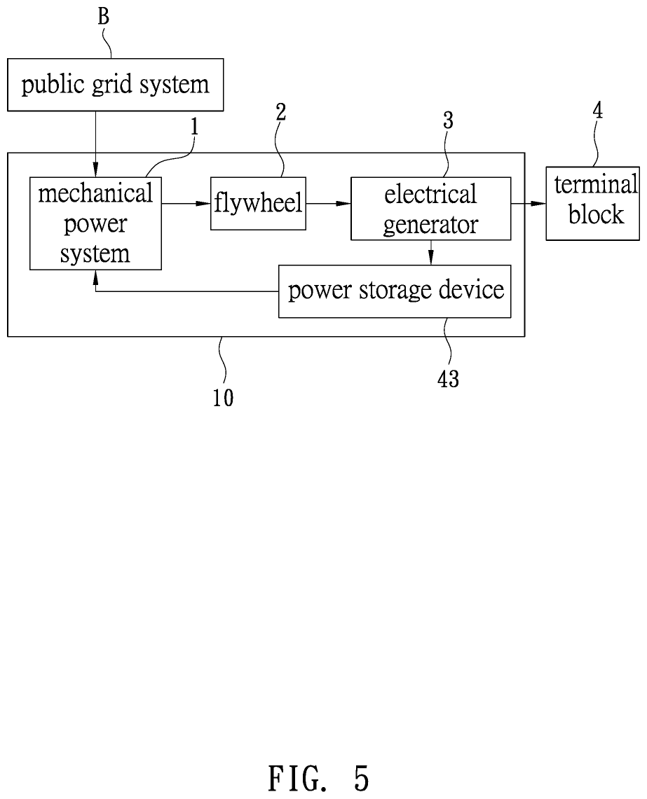

The mechanical power system 1 includes a motor 11 capable of being energized by an initial power supply (A), wherein the initial power supply (A) can be a public grid system (B) as shown in FIG. 5.

The flywheel 2 is connected to the mechanical power system 1 such that the flywheel 2 can be rotated by the mechanical power system 1, and due to the principle of inertia, a larger torque can be produced.

The electrical generator 3 can be coupled to the flywheel 2 by a belt 21 engaged with a central shaft 20 of the flywheel 2 so that the electrical generator 3 can generate electrical power for homes, factories, and any places where electricity is needed. Surplus power at the electrical generator 3 can be fed back to a power storage device 43, which has the function of providing electrical power to initiate the mechanical power system 1 and can cooperate with the public grid system (B) to facilitate energizing the mechanical power system 1.

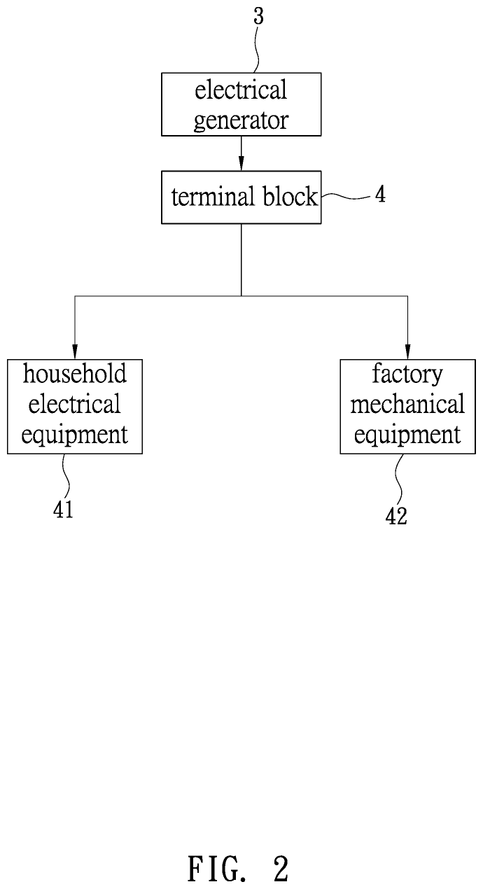

Referring to FIG. 2, the electrical generator 3 can be provided with a terminal block 4, through which household electrical equipment 41 and factory mechanical equipment 42 can be energized.

In general, the output torque of the household electrical equipment 41 or the factory mechanical equipment 42 is proportional to the amount of electrical power required for the household electrical equipment 41 or the factory mechanical equipment 42. Based on the principle of inertia, the flywheel 2 enables the mechanical power system 1 to provide a large torque for the electrical generator 3. In other words, the electrical generator 3 can generate the same electricity with less power input from the public grid system (B), thus achieving the effect of energy saving.

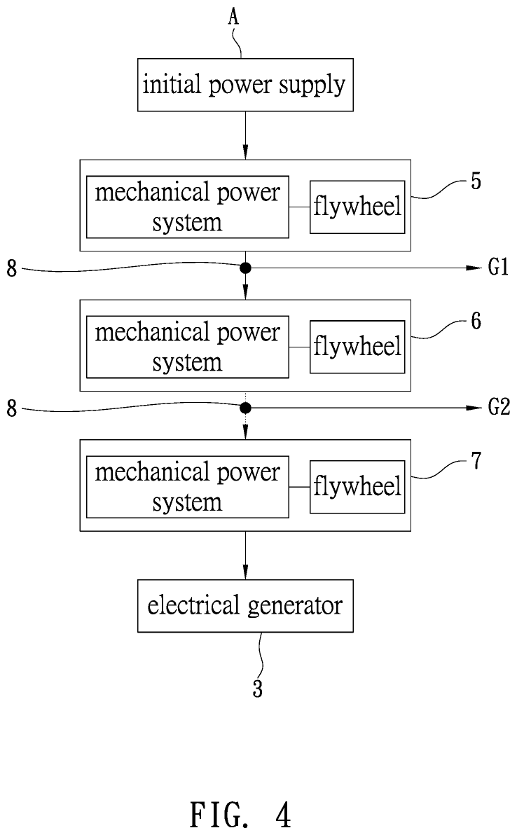

Referring to FIG. 4, the power-saving electrical device 10 may include multiple sets 5, 6, 7 of power systems and flywheels serially connected between the set comprised of the mechanical power system 1 and the flywheel 2, and the electrical generator 3. Due to the principle of inertia, the first set 5 can produce a large torque to drive the second set 6, and thus the second set 6 can produce a larger torque to drive the third set 7. As such, the final set 7 can provide a much larger torque for the electrical generator 3 to generate electricity for homes or factories, and surplus power at the electrical generator 3 can be fed back to one or more power storage deices. In addition, a switching device 8 can be provided between two adjacent sets of mechanical power systems and flywheels to enable mechanical power to be transferred to another electrical generator (G1) or (G2) which is operated at a different torque.

As a summary, the present invention provides a power-saving electrical device 10, which employs a mechanical power system 1 to rotate a flywheel 2. Due to the principle of inertia, a large torque can be produced. An electrical generator 3 is coupled to the flywheel 2 so that the electrical generator 3 can generate a large amount of electrical power, thus achieving the effect of energy saving. Furthermore, surplus power at the electrical generator 3 can be fed back to a power storage device 43, which has the function of providing electrical power to initiate the mechanical power system 1.

What is claimed is:

1. A power-saving electrical device, comprising:
a first mechanical power system capable of being energized by an initial power supply;
a first flywheel connected to the mechanical power system, so that the flywheel can be rotated by the mechanical power system; and
an electrical generator coupled to an output shaft of the first flywheel for generating electrical power for homes and factories, wherein surplus power at the electrical generator is fed back to a power storage device.

2. The power-saving electrical device of claim 1, wherein the initial power supply is a public grid system.

3. The power-saving electrical device of claim 1, wherein the mechanical power system includes a motor.

4. The power-saving electrical device of claim 2, wherein the electrical generator is coupled to the output shaft of the flywheel by a belt, the power storage device capable of cooperating with the public grid system to facilitate energizing the mechanical power system.

5. The power-saving electrical device of claim 1, wherein the electrical generator is provided with a terminal block, through which household electrical equipment and factory mechanical equipment can be energized.

6. The power-saving electrical device of claim 1, further comprising additional sets of mechanical power systems and flywheels serially connected between the set comprised of the first mechanical power system and the first flywheel, and the electrical generator, so that the electrical generator receives a much larger torque to generate electricity for homes and factories, and surplus power is fed back to the power storage device; a switching device is provided between two adjacent sets of mechanical power systems and flywheels for selectively transferring mechanical power to another electrical generator which is operated at a different torque.
